(19) United States
(12) Patent Application Publication
(10) Pub. No.: US 2017/0344398 A1
(43) Pub. Date: Nov. 30, 2017

(54) ACCELERATOR CONTROL DEVICE, ACCELERATOR CONTROL METHOD, AND PROGRAM STORAGE MEDIUM

(71) Applicant: NEC CORPORATION, Tokyo (JP)

(72) Inventors: Jun SUZUKI, Tokyo (JP); Masaki KAN, Tokyo (JP); Yuki HAYASHI, Tokyo (JP)

(73) Assignee: NEC CORPORATION, Tokyo (JP)

(21) Appl. No.: 15/520,979

(22) PCT Filed: Oct. 9, 2015
(86) PCT No.: PCT/JP2015/005149

§ 371 Date: Apr. 21, 2017

(30) Foreign Application Priority Data
Oct. 23, 2014 (JP) 2014--215968

(51) Int. Cl. G06F 9/50; G06F 9/48; G06F 17/30

(52) U.S. Cl. CPC G06F 9/5016; G06F 17/30979; G06F 9/4881; G06F 17/30958

(57) ABSTRACT

In order to increase the speed of a computation process using an accelerator, an accelerator control device 1 is provided with a generation unit 12 and a control unit 14. The generation unit 12 generates a directed acyclic graph (DAG) representing the process flow based on a computer program to be executed. If data corresponding to a DAG node is stored in a memory provided in an accelerator to be controlled, the control unit 14 controls the accelerator so as to execute a process corresponding to an edge of the DAG using the data stored in the memory of the accelerator.

### TECHNICAL FIELD

The present invention relates to a technique regarding a computer system that executes a calculation process with use of an accelerator.

### BACKGROUND ART

NPL 1 describes an example of a computer control system. The computer control system described in NPL 1 includes, as illustrated in FIG. 11, a driver host 6, and worker hosts 8-1 to 8-3. The driver host 6 and the worker hosts 8-1 to 8-3 are connected by a network 7. The worker hosts 8-1 to 8-3 are computers which execute a calculation process. The driver host 6 is a computer which controls the calculation process in the worker hosts 8-1 to 8-3. Note that the number of worker hosts may vary as long as there is at least one, and is not limited to three, as exemplified in FIG. 11.

The computer control system illustrated in FIG. 11 is operated as follows.

The driver host 6 holds a directed acyclic graph (DAG) representing a process flow to be executed by the worker hosts 8-1 to 8-3. FIG. 4 illustrates an example of the DAG. Each node of the DAG illustrated in FIG. 4 indicates data, and an edge connecting between nodes indicates a process. According to the DAG illustrated in FIG. 4, when a computer executes a process 5-1 for data (a node) 4-1, data 4-2 is generated. Then, when a computer executes a process 5-2 for the data 4-2, data 4-3 is generated. Accordingly, when a computer receives two data, i.e., data 4-3 and data 4-4, and executes a process 5-3 for the two data, data 4-5 is generated. Further, when a computer executes a process 5-4 for the data 4-5, data 4-6 is generated.

In this example, data 4-1 is constituted by a plurality of pieces of split data 4A-1, 4B-1, . . . as illustrated in FIG. 12, for instance. Further, the other data 4-2, 4-3, . . . are respectively constituted by the plurality of pieces of split data in the same manner. Note that the number of split data constituting each of the data 4-1 to 4-6 is not limited to two or more, but may be one. In the present specification, even when the number of split data constituting data is one, in other words, even when split data is not part of data but whole data, the data is described as split data.

The driver host 6 causes the worker hosts 8-1 to 8-3 to process data in the respective edges (processes) of the DAG in FIG. 4. For instance, regarding the process 5-1 by which the data 4-1 is processed, the driver host 6 causes the worker host 8-1 to process the split data 4A-1 illustrated in FIG. 12, causes the worker host 8-2 to process the split data 4B-1, and causes the worker host 8-3 to process the split data 4C-1, respectively. In other words, the driver host 6 controls the worker hosts 8-1 to 8-3 in such a manner that data is processed in parallel.

The computer control system illustrated in FIG. 11 is capable of improving processing performance of a target process by employing the aforementioned configuration and by increasing the number of worker hosts.

Note that PTL 1 describes a technique relating to a parallel processing system. In PTL 1, when command data is associated with a plurality of pieces of status data, an accelerator causes a processing device to process the command data, depending on the number of times of reading the command data, and a predetermined number of times of being associated with the command data.

Further, PTL 2 describes a technique relating to an image processing device provided with a plurality of processors which use memory areas different from each other. In PTL 2, a buffer module transfers image data written in the buffer by a preceding process to a transfer buffer, which is secured in a memory area to be used by a succeeding process. In the succeeding process, image data transferred to the transfer buffer is read, and the image data is processed.

Further, PTL 3 relates to a command scheduling method. PTL 3 discloses a technique, in which there is configured a schedule for executing commands by using a command block as a unit.

### CITATION LIST

### Patent Literature

[PTL 1] Japanese Laid-open Patent Publication No. 2014-149745
[PTL 2] Japanese Laid-open Patent Publication No. 2013-214151
[PTL 3] Japanese Laid-open Patent Publication No. H03 (1991)-135630

### Non Patent Literature

[NPL 1] M. Zaharia et al., “Resilient Distributed Datasets: A Fault-Tolerant Abstraction for In-Memory Cluster Computing,” NSDI'12 Proceeding of the 9th USENIX conference on Networked Systems Design and Implementation, 2012

### SUMMARY OF INVENTION

### Technical Problem

In the computer control system described in NPL 1, there is a problem that it is not possible to perform calculation using the worker hosts 8-1 to 8-3 (namely, accelerators) at high speed. The reason for this is that memories of the worker hosts (accelerators) 8-1 to 8-3 are not efficiently used. Further, when it is not possible to store output data which is data generated by a process in memories of the worker hosts 8-1 to 8-3, the output data is transferred (swapped) from the worker hosts 8-1 to 8-3 to the driver host 6. Further, when the output data is processed, the output data is stored (loaded) in the memories of the worker hosts 8-1 to 8-3 from the driver host 6. In this way, when it is not possible to store output data in memories of the worker hosts 8-1 to 8-3, data communication between the driver host 6 and the worker hosts 8-1 to 8-3 occurs frequently. This is one of the reasons why a computer control system cannot execute calculation at high speed.

The present invention is made in order to solve the aforementioned problem. Specifically, a main object of the present invention is to provide a technique capable of speeding up a calculation process that uses an accelerator.

### Solution to Problem

To achieve the main object, an accelerator control device of the present invention includes:

generation means for generating a DAG (Directed Acyclic Graph) representing a process flow based on a computer program to be executed; and

control means for, when data relating to a node of the DAG is stored in a memory provided in an accelerator to be controlled, controlling the accelerator so as to execute a process relating to an edge of the DAG with use of the data stored in the memory of the accelerator.

An accelerator control method of the present invention includes, by a computer:

generating a DAG (Directed Acyclic Graph) representing a process flow based on a computer program to be executed; and

when data relating to a node of the DAG is stored in a memory provided in an accelerator to be controlled, controlling the accelerator so as to execute a process relating to an edge of the DAG with use of the data stored in the memory of the accelerator.

A program storage medium stores a processing procedure which causes a computer to execute:

generating a DAG (Directed Acyclic Graph) representing a process flow based on a computer program to be executed; and

when data relating to a node of the DAG is stored in a memory provided in an accelerator to be controlled, controlling the accelerator so as to execute a process relating to an edge of the DAG with use of the data stored in the memory of the accelerator.

Note that the main object of the present invention is also achieved by an accelerator control method according to the present invention, which is associated with the accelerator control device according to the present invention. Further, the main object of the present invention is also achieved by a computer program and a program storage medium storing the computer program, which are associated with the accelerator control device and the accelerator control method according to the present invention.

### Advantageous Effects of Invention

According to the present invention, it is possible to speed up a calculation process that uses an accelerator.

### BRIEF DESCRIPTION OF DRAWINGS

FIG. 1A is a block diagram illustrating a schematic configuration of an accelerator control device according to the present invention.

FIG. 1B is a block diagram illustrating a modification example of the configuration of the accelerator control device illustrated in FIG. 1A.

FIG. 2 is a block diagram illustrating a configuration example of a computer system provided with the accelerator control device of a first example embodiment.

FIG. 3 is a diagram describing an example of a reservation API (Application Programming Interface) and an execution API (Application Programming Interface).

FIG. 4 is a diagram illustrating an example of a DAG.

FIG. 5 is a diagram illustrating an example of a memory management table in the first example embodiment.

FIG. 6 is a diagram illustrating an example of a data management table in the first example embodiment.

FIG. 7 is a diagram describing an example of data to be processed by an accelerator.

FIG. 8 is a diagram describing another example of data to be processed by the accelerator.

FIG. 9 is a flowchart illustrating an operation example of the accelerator control device of the first example embodiment.

FIG. 10 is a flowchart illustrating an operation example of a memory management unit in the accelerator control device of the first example embodiment.

FIG. 11 is a block diagram describing a configuration example of a computer control system.

FIG. 12 is a diagram describing a configuration of data to be processed by a computer control system.

FIG. 13 is a block diagram illustrating a configuration example of hardware components constituting an accelerator control device.

### DESCRIPTION OF EMBODIMENTS

In the following, an example embodiment according to the present invention is described referring to the drawings.

First of all, a summary of the example embodiment according to the present invention is described.

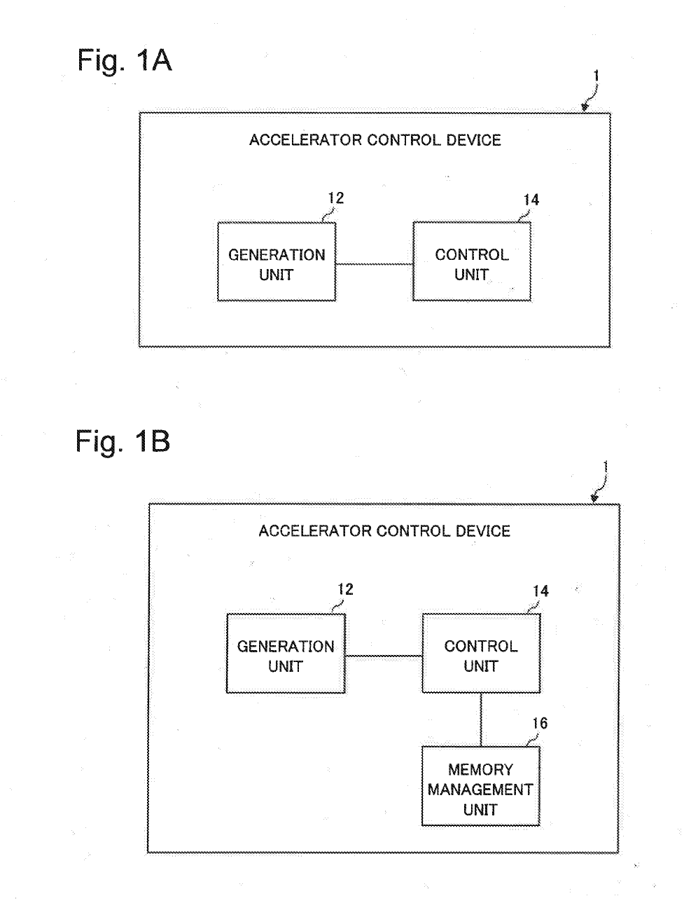

FIG. 1A is a block diagram briefly illustrating a configuration of an example embodiment of an accelerator control device according to the present invention. The accelerator control device 1 illustrated in FIG. 1A is connected to an accelerator (not illustrated), and has a function of controlling an operation of the accelerator. The accelerator control device 1 includes a generation unit 12 and a control unit 14. The generation unit 12 has a function of generating a DAG (Directed Acyclic Graph) representing a process flow based on a computer program (hereinafter, also referred to as a user program) to be executed. When data corresponding to a node of the DAG is stored (loaded) in a memory provided in the accelerator, the control unit 14 controls the accelerator to execute a process corresponding to an edge of the DAG with use of the data stored in the memory.

Note that when processes corresponding to a plurality of edges of the DAG are successively executable with use of split data, which is whole or part of data corresponding to the node of the DAG, the control unit 14 may control the accelerator as follows. Specifically, each time a process is finished for successively processable split data, the control unit 14 may control the accelerator to successively execute a plurality of processes for the data without erasing (swapping) the data from the memory of the accelerator.

As described above, the accelerator control device 1 controls the accelerator in such a manner that data (cached data) stored in the memory of the accelerator is used for a DAG process. Therefore, the accelerator control device 1 can reduce time required for loading data as compared with a case where data to be processed is provided from the accelerator control device 1 to the accelerator for storing (loading) the data, each time the accelerator control device 1 causes the accelerator to execute a process. This enables the accelerator control device 1 to speed up the process that uses the accelerator. In addition, the accelerator control device 1 can reduce service cost required for loading data to the accelerator. Further, controlling the accelerator in such a manner that a plurality of processes are successively executed for data to be processed enables the accelerator control device 1 to speed up the process that uses the accelerator. In other words, by the aforementioned control, the accelerator control device 1 can reduce a process of transferring (swapping) data from the accelerator to the accelerator control device 1, and providing (re-loading) data to the accelerator. This enables the accelerator control device 1 to speed up the process that uses the accelerator, and to reduce service cost required for loading data.

Note that as illustrated in FIG. 1B, the accelerator control device 1 may further include a memory management unit 16. The memory management unit 16 has a function of managing the memory provided in the accelerator to be controlled by the accelerator control device 1. When the memory management unit 16 is provided, the control unit 14 requests the memory management unit 16 for a memory resource of the accelerator, which is necessary for a process indicated in the DAG. The memory management unit 16 may release part of the memory for securing memory capacity necessary for a process (in other words, permit storing new data after already stored data is erased). In this case, the memory management unit 16 releases memory area storing data that is not used in any subsequent process in the DAG, or data for which a cache (temporary storage) request based on the user program is not received out of releasable memory areas. Further, the memory management unit 16 secures the memory area according to the memory capacity necessary for a process, including the memory area released as described above, and allocates the secured memory area as the memory area for use in the DAG process.

When cached data (cache data) is stored in the memory of the accelerator, the control unit 14 controls the accelerator to use the cache data for the DAG process. In this way, the accelerator control device 1 controls the accelerator in such a manner as to execute a process that uses cache data. This makes it possible to reduce the number of times of loading data to the accelerator, whereby it is possible to reduce service cost required for loading data. Further, the accelerator control device 1 can reduce the number of times of loading data, whereby it is possible to speed up the process.

Further, when the memory capacity of the accelerator for a process is insufficient, but when it is possible to successively execute a plurality of processes for data, the control unit 14 causes the accelerator to successively execute a plurality of processes by loading data to the memory of the accelerator by one-time operation. In this way, the accelerator control device 1 controls the accelerator in such a manner as to successively execute a plurality of processes by loading data to the accelerator by one-time operation. This makes it possible to reduce the number of times of transferring (swapping) data from the accelerator and the number of times of loading data. This enables the accelerator control device 1 to reduce service cost required for data swapping and loading. Further, the accelerator control device 1 can reduce the number of times of loading data, whereby it is possible to speed up the process.

### First Example Embodiment

In the following, an accelerator control device of the first example embodiment according to the present invention is described.

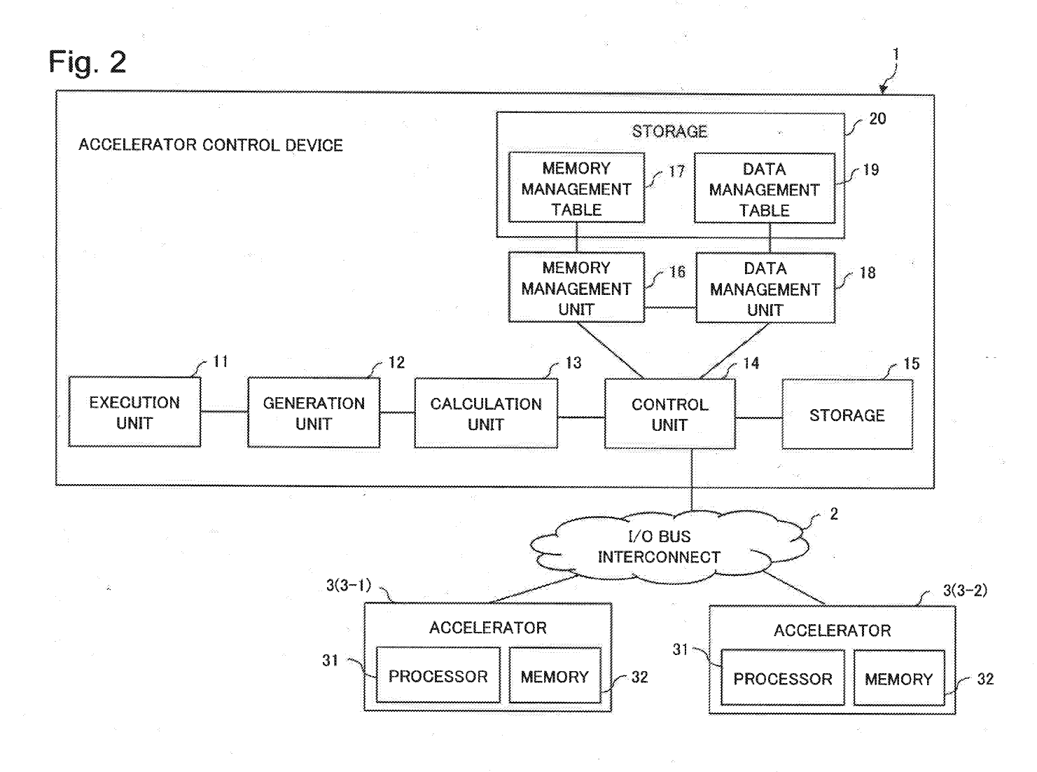

FIG. 2 is a block diagram briefly illustrating a configuration of a computer system provided with the accelerator control device 1 of the first example embodiment. The computer system includes accelerators 3-1 and 3-2 which execute a calculation process, and the accelerator control device 1 which controls the accelerators 3-1 and 3-2. The accelerators 3-1 and 3-2, and the accelerator control device 1 are connected by an I/O (Input/Output) bus interconnect 2.

Note that in the example of FIG. 2, the two accelerators 3-1 and 3-2 are illustrated. The number of accelerators, however, may vary as long as there is at least one. In this example, the accelerator is a co-processor to be connected to a computer via an I/O bus. For instance, a GPU (Graphics Processing Unit) of NVIDIA Corporation and Xeon Phi (registered trademark) of Intel Corporation are known as a co-processor.

Further, the accelerators 3-1 and 3-2 have a common configuration as described in the following. Further, a same control is performed for the accelerators 3-1 and 3-2 by the accelerator control device 1. In the following, to simplify the description, the accelerators 3-1 and 3-2 are also simply referred to as the accelerator 3.

The accelerator 3 includes a processor 31 which processes data, and a memory 32 which stores data.

The accelerator control device 1 includes an execution unit 11, a generation unit 12, a calculation unit 13, a control unit 14, a storage 15, a memory management unit 16, a data management unit 18, and a storage 20.

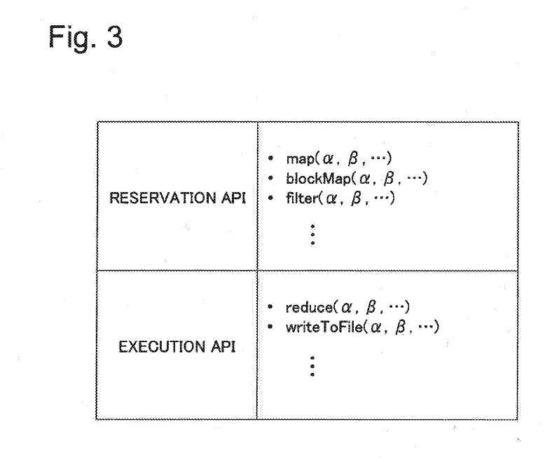

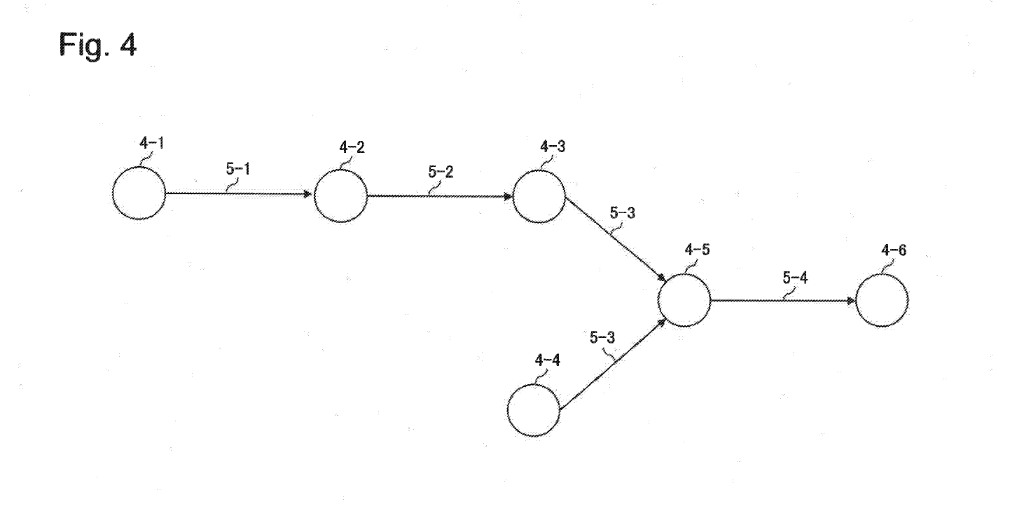

The execution unit 11 has a function of executing the user program. In the first example embodiment, a reservation API (Application Programming Interface) and an execution API (Application Programming Interface) as illustrated in FIG. 3 are provided for the accelerator control device 1. The user program is executed by using (calling) the reservation API and the execution API. The reservation API corresponds to an edge of the DAG illustrated in FIG. 4, specifically, a process.

The generation unit 12 has a function of generating the DAG representing a processing order requested by the user program. For instance, when the reservation API is called and executed based on the user program, the generation unit 12 generates (adds), to the DAG, the edge and the node of the DAG, specifically, the process and data to be generated by the process.

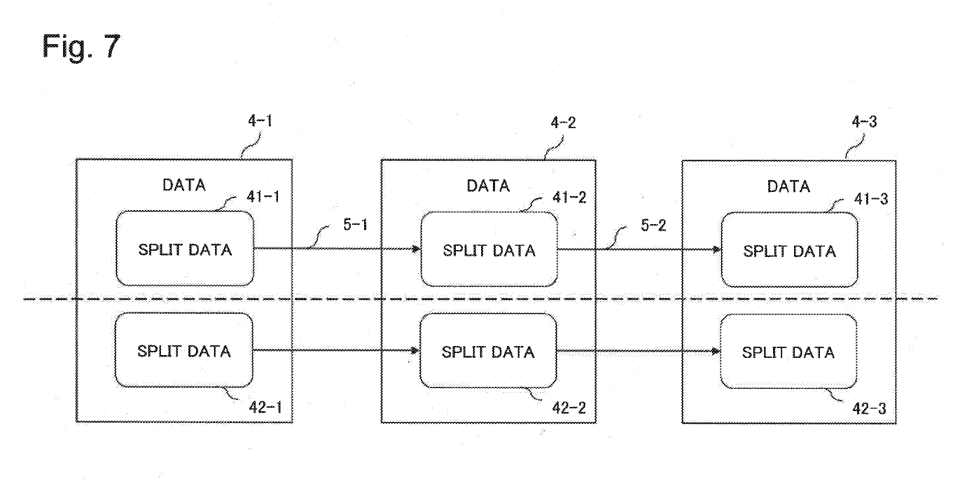

Respective pieces of data of the DAG is constituted by split data as illustrated in FIG. 7. Note that in the following description, respective data portions obtained by splitting data into a plurality of pieces of data is referred to as split data. However, even when data is not split, whole data (the entirety of data) may also be referred to as split data.

The reservation API illustrated in FIG. 3 is an API for use in reserving a process. In other words, even when the reservation API is executed, a process by the accelerator 3 is not executed, and only the DAG is generated. Further, when the execution API is called, there is a case in which a new edge and a new node are generated in the DAG by the generation unit 12, and a case in which the new edge and the new node are not generated by the generation unit 12. When the execution API is executed, execution of the DAG process that is generated so far is triggered (enabled). An example of the process belonging to the execution API includes such as a process which requires data after the DAG is processed within the user program, a process of completing a program after a description of the DAG such as writing a file is completed by writing or displaying a result, and the like.

As illustrated in FIG. 3, there is a case in which the reservation API or the execution API has one or a plurality of arguments α, β, . . . . One of the arguments is called a Kernel function. The Kernel function is a function representing a process to be executed for data by the user program. Specifically, the reservation API or the execution API represents an access pattern of a process to be executed for data. An actual process is executed based on the Kernel function, which is given as an argument of the reservation API and the execution API in the user program. Further, another one of the arguments is a parameter, which indicates size of output data to be generated by a process that uses the reservation API or the execution API, and the Kernel function to be given to these interfaces.

For instance, in the case of a process 5-1 to be executed for data 4-1 in FIG. 4, a parameter indicates quantity of data 4-2 to be generated. Note that as a method for indicating the quantity, for instance, there is used a method which gives an absolute value of the quantity of the data 4-2 to be generated. Further, as a method for indicating the quantity, there may be used a method which gives a relative ratio between the quantity of the data 4-1 serving as data (input data) to be processed and the quantity of the data 4-2 serving as data (output data) to be generated.

Further, in response to a request based on the user program, regarding data to be repeatedly used in a plurality of DAGs, the execution unit 11 may ask (request) the generation unit 12 to preferentially cache the data to the accelerator 3.

The generation unit 12 generates the DAG each time the execution unit 11 reads the reservation API and the execution API. When the reservation API is called, the generation unit 12 adds, to the DAG, the edge and the node according to the reservation API. Further, when the execution API is executed, the generation unit 12 adds the edge and the node as necessary, and notifies the calculation unit 13 of the DAG generated so far.

Note that the DAG to be generated by the generation unit 12 includes a type of the reservation API or the execution API, which is associated with the process based on the user program, and the Kernel function given to each API. The DAG further includes information relating to quantity of data to be generated in each process, or quantity of data indicated by each node such as a quantity ratio between data indicated by the node on the input side of a process and data indicated by the node on the output side. Further, the generation unit 12 attaches information (a mark) indicating data to be cached, to the node (data) for which caching is performed in the DAG based on a request from the execution unit 11.

The calculation unit 13 receives the DAG generated by the generation unit 12, calculates the number of threads and the memory capacity (a memory resource) in the memory 32 of the accelerator 3, which is necessary in each process of the received DAG, and transfers the DAG and necessary resource information to the control unit 14.

The storage 15 has a configuration for storing data. In the first example embodiment, the storage 15 stores data to be provided and stored (loaded) in the memory 32 of the accelerator 3.

After the accelerator control device 1 is enabled, the memory management unit 16 secures the entirety of the memory 32 of the accelerator 3, and manages the secured memory resources by dividing the secured memory resources into pages of a fixed size. The page size is 4 KB or 64 KB, for instance.

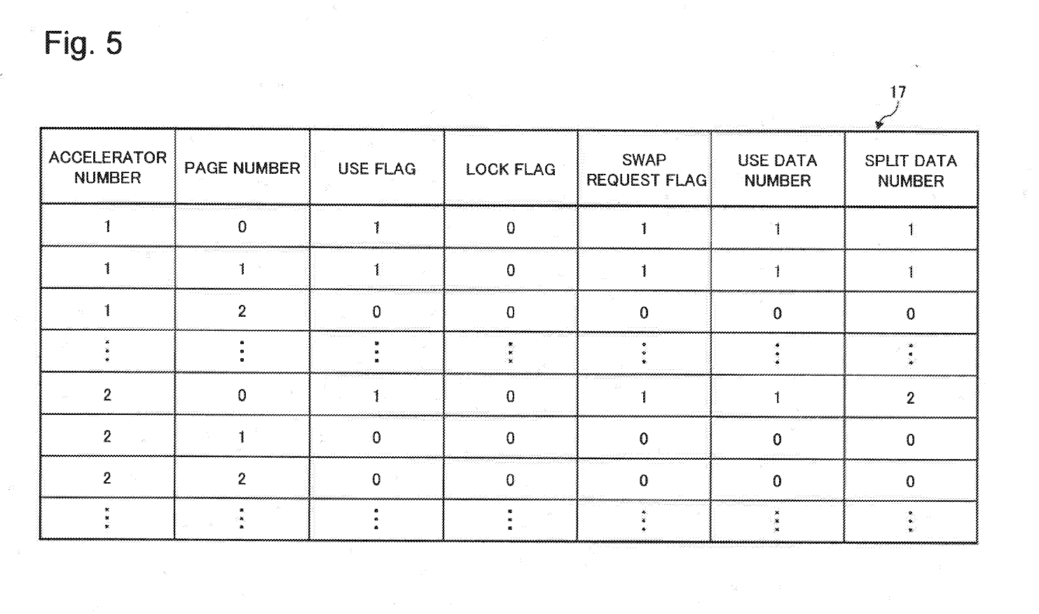

The storage 20 stores a memory management table 17, which is management information for use in managing the memory 32. FIG. 5 is a diagram illustrating an example of the memory management table 17. The memory management table 17 stores information relating to each page. For instance, page information includes an accelerator number for identifying the accelerator 3 to which a page belongs, a page number, and a use flag indicating that data under calculation or after calculation are stored in a page. Further, page information includes a lock flag indicating that the page is being used for calculation, and releasing is prohibited. Further, page information includes a swap request flag indicating that swapping is necessary because the page is necessary in any subsequent process in the DAG when the page is released. Furthermore, page information includes a use data number indicating data to be held in the page, and split data number indicating which a piece of split data of the respective data is held when the use flag is asserted (enabled). The use data number is an identifier to be allocated to the node of the DAG.

The memory management unit 16 manages the memory 32 of the accelerator 3 by referring to the memory management table 17. In response to receiving a request from the control unit 14, the memory management unit 16 first checks whether it is possible to secure a number of pages the corresponding to a requested capacity only from pages (free pages) in which the use flag is not asserted. When it is possible to secure, the memory management unit 16 asserts the use flag and the lock flag of these pages, and responds to the control unit 14 that securing is completed.

Further, when it is not possible to secure the number of pages corresponding to the requested capacity only from free pages, the memory management unit 16 secures the number of pages corresponding to the requested capacity as follows. Specifically, in addition to free pages, the memory management unit 16 secures a necessary number of pages by also using the page in which the use flag is asserted and in which the lock flag and the swap request flag are not asserted. Further, the memory management unit 16 asserts the use flag and the lock flag of the secured page, and replies to the control unit 14 that securing is completed. In this case, the memory management unit 16 erases data held in the secured page.

Further, the memory management unit 16 notifies the data managing unit 18 of the data number, the split data number, and the page number of data to be erased. Note that when the piece of split data of a piece of data is held in a plurality of pages in a distributed manner, in releasing the memory, the memory management unit 16 releases this plurality of pages all at once.

Further, there is a case that it is not possible to secure the necessary number of pages even when combining free pages, and the page in which the use flag is asserted and in which the lock flag and the swap request flag are not asserted. In this case, the memory management unit 16 secures the number of pages corresponding to the necessary capacity by using the page other than locked pages out of the remaining pages. In this case, regarding the page in which a swap flag is asserted, the memory management unit 16 swaps (transfers) data stored in the page to the storage 15, and releases the page in which the transferred data is stored. The memory management unit 16 swaps or erases data by using the piece of split data of one data as a unit. In this case, the memory management unit 16 notifies the data management unit 18 of the data number, the split data number, and the page number of split data which is swapped to the storage 15, or split data in which the swap request flag is not asserted and which is erased by a memory release operation.

Further, when it is not possible to secure the number of pages corresponding to the capacity requested by the control unit 14 due to shortage in the number of usable pages, the memory management unit 16 responds to the control unit 14 with an error message indicating that it is not possible to secure the memory capacity.

Further, when the memory management unit 16 receives a query regarding securable memory information from the control unit 14, the memory management unit 16 responds the control unit 14 with memory information securable at that point of time. Further, in response to a request from the control unit 14, the memory management unit 16 asserts the swap request flag of the page managed by the memory management unit 16, and releases assertion of the lock flag of the page, for which calculation is finished and which is used for calculation.

The data management unit 18 manages data to be held in the memory 32 of the accelerator 3 with use of the data management table 19.

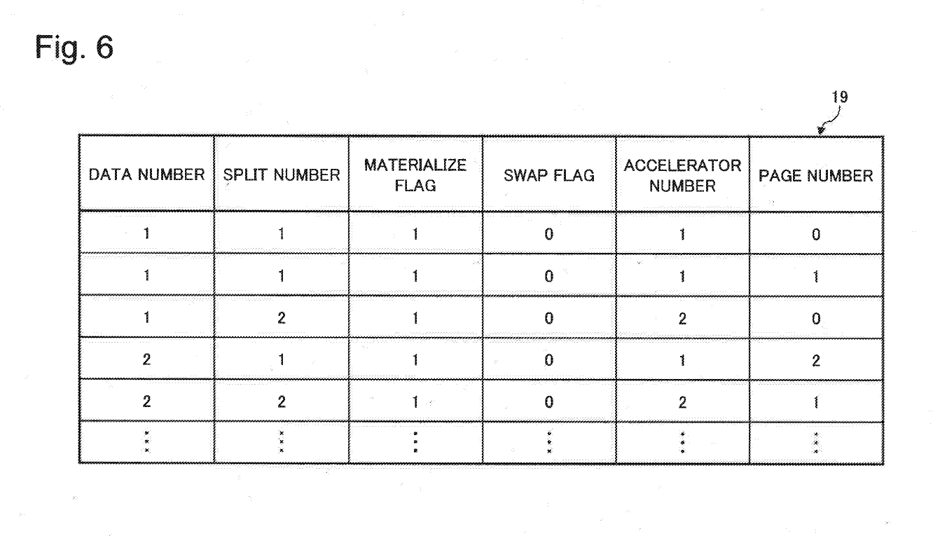

The storage 20 stores the data management table 19 for use in management of data stored in the memory 32 of the accelerator 3. FIG. 6 is a diagram illustrating an example of the data management table 19. The data management table 19 stores information relating to the respective data. Data information includes a data number for identifying data, a data split number, a materialize flag indicating in which one of the memory 32 of the accelerator 3 and the storage 15 data is stored, and the swap flag indicating that data is swapped (transferred) to the storage 15. Further, data information includes the accelerator number indicating the accelerator 3 which stores data in which the materialize flag is asserted and in which the swap flag is not asserted, and a page number of the memory 32 of the accelerator 3 which stores data. Note that the materialize flag is asserted when data is stored in the memory 32 of the accelerator 3.

When the query relating to the existence of data is received from the control unit 14, the data management unit 18 checks whether data being queried already exist with use of the data management table 19. In addition to the above, the data management unit 18 checks whether the materialize flag and the swap flag of the data to be queried are respectively asserted based on the data management table 19. Subsequently, the data management unit 18 responds to the control unit 14 with the check result. Further, when a notification is received from the memory management unit 16, the data management unit 18 sets the materialize flag of data which is erased from the memory 32 of the accelerator 3 to 0. Further, the data management unit 18 asserts the swap flag of data swapped from the memory 32 of the accelerator 3 to the storage 15.

When the control unit 14 receives the DAG generated by the generation unit 12 and necessary resource information calculated by the calculation unit 13 from the calculation unit 13, the control unit 14 executes a process designated in the DAG. In this case, the control unit 14 queries the data management unit 18 for the data number designated in the DAG, and checks whether the data is already calculated and the materialize flag is asserted, or the swap flag is asserted. Further, the control unit 14 queries the memory management unit 16 for securable memory capacity. Further, the control unit 14 executes a process by an execution procedure of processing the DAG at high speed.

In other words, regarding data which is already calculated, and in which the materialize flag is asserted and the swap flag is not asserted, the control unit 14 caches the data into the memory 32 of the accelerator 3, and uses the cached data. This makes it possible to omit a process of loading and generating the data.

Further, regarding data in which both of the materialize flag and the swap flag are asserted, the control unit 14 requests the memory management unit 16 for the memory capacity necessary for loading data swapped in the storage 15. Further, when receiving a response from the memory management unit 16 that securing is completed, the control unit 14 loads data in a designated page, and uses the data. This makes it possible to omit a process of generating the data.

In this way, the control unit 14 executes a process for data which is already stored in the memory 32 of the accelerator 3 more preferentially than a process for data which does not exist in the memory 32. This makes it possible to reduce service cost due to loading of data swapped in the storage 15 onto the memory 32 of the accelerator 3 at the time of processing.

Further, for instance, there is a case where it is not possible to store, in the memory 32 of the accelerator 3, both of data 4-1 in the DAG illustrated in FIG. 4 and data 4-2 which is data (output data) generated by processing the data 4-1, due to shortage of quantity. In other words, there is a case where it is not possible to fit the total quantity of data to be processed by the accelerator 3 into the memory 32 of the accelerator 3. In this case, the control unit 14 controls the accelerator 3 as follows. Note that, as illustrated in FIG. 7, data 4-1 to 4-3 in the DAG are respectively split into a plurality of pieces of split data.

Specifically, as the processing order of the accelerator 3, there is a processing order such that after a process 5-1 is executed for split data 41-1 and 42-1 of data 4-1 in this order, a process 5-2 is executed for split data 41-2 and 42-2 of data 4-2 in this order. On the other hand, the control unit 14 controls the accelerator 3 with the processing order such that after the process 5-1 is executed for the split data 41-1 of the data 4-1, the process 5-2 is executed for the split data 41-2 of the data 4-2. In this way, the control unit 14 lowers a possibility that the split data 41-2 of the data 4-2 may be swapped from the memory 32 of the accelerator 3 into the storage 15.

The control unit 14 may execute control (optimization) of successively executing a process for split data not only when there are two sequential processes as exemplified in FIG. 7, but also when there are three or more sequential processes.

Note that when a process is executed with use of a plurality of accelerators 3, the control unit 14 causes the plurality of accelerators 3 to distribute the plurality of pieces of split data, and to execute a same process corresponding to the edge of the DAG in parallel for the respective pieces of split data.

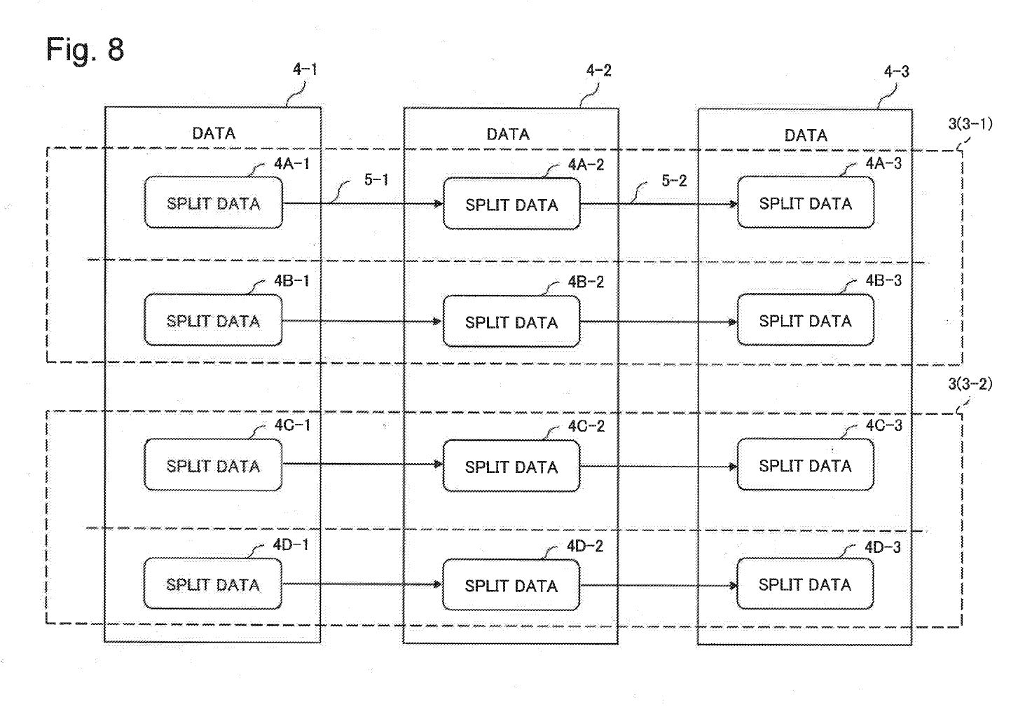

Further, as illustrated in FIG. 8, even when the number of pieces of split data constituting data is larger than the number illustrated in FIG. 7, the control unit 14 controls each accelerator 3 to successively execute the process 5-1 and the process 5-2 for the split data in the same manner as described above.

Further, when the control unit 14 causes the accelerator 3 to execute a process corresponding to each edge of the DAG, and when split data to be processed are not stored in the memory 32 of the accelerator 3, the control unit 14 performs the following operation. Specifically, the control unit 14 loads data to be processed to the accelerator 3, and requests the memory management unit 16 for securing, in the memory 32 of the accelerator 3, a number of pages corresponding to the memory capacity necessary for outputting output data. Further, the control unit 14 causes the accelerator 3, which executes a process, to load data to be processed from the storage 15 and to execute the process.

Further, when a process is finished, the control unit 14 notifies the memory management unit 16 that the process is finished, and releases locking of a used memory page by use of the memory management unit 16. Further, regarding data necessary in any subsequent process in the DAG, the control unit 14 releases assertion of the lock flag, and notifies the memory management unit 16 to assert the swap flag. In addition, regarding data having a mark indicating a cache request attached thereto for use as data to be used in a plurality of DAGs, the control unit 14 notifies the memory management unit 16 to assert the swap flag of the page number corresponding to data in the data management table 19.

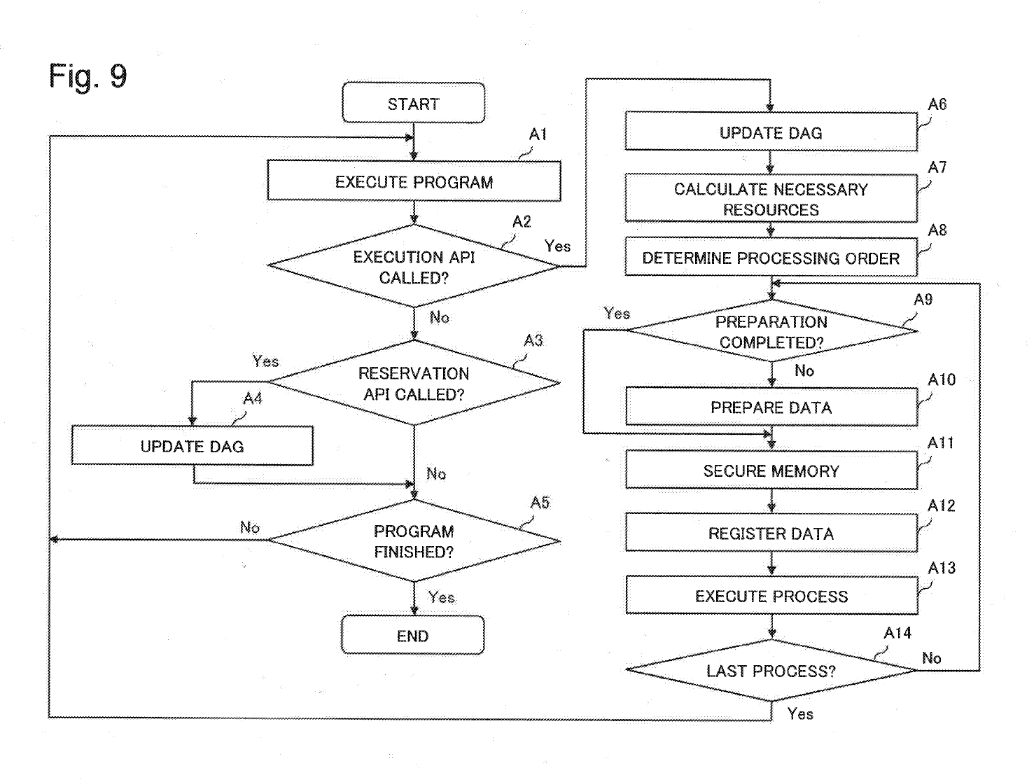

Next, an operation example of the accelerator control device 1 in the first example embodiment is described using FIG. 2 and FIG. 9. FIG. 9 is a flowchart illustrating an operation example of the accelerator control device 1 in the first example embodiment. Note that the flowchart illustrated in FIG. 9 illustrates a processing procedure to be executed by the accelerator control device 1.

The execution unit 11 executes the user program using the reservation API and the execution API (Step A1).

Thereafter, the generation unit 12 determines whether a process of the user program executed by the execution unit 11 is a process called (read) and executed by the execution API (Step A2). Further, when the executed process of the user program is not a process called by the execution API (No in Step A2), the generation unit 12 checks whether the process is a process called and executed by the reservation API (Step A3). When the process is a process called by the reservation API (Yes in Step A3), the generation unit 12 adds, to the DAG generated so far, a process designated by the reservation API, and the edge and the node corresponding to data to be generated by the process. In other words, the generation unit 12 updates the DAG (Step A4).

Thereafter, the execution unit 11 checks whether a command of the executed user program is a last command of the program (Step A5). When the command is the last command (Yes in Step A5), the execution unit 11 ends the process based on the user program. On the other hand, when the command is not the last command (No in Step A5), the execution unit 11 returns to Step A1, and continues execution of the user program.

On the other hand, in Step A2, when the process of the user program executed by the execution unit 11 is a process called by the execution API (Yes in Step A2), the generation unit 12 proceeds to a process (Steps A6 to A14) of transmitting the DAG generated so far.

Specifically, the generation unit 12 updates the DAG by adding, to the DAG, an executed process, and the edge and the node corresponding to generated data as necessary (Step A6), and transmits the DAG to the calculation unit 13.

The calculation unit 13 calculates the number of threads and the memory capacity of the accelerator necessary in a process corresponding to each edge of the given DAG (Step A7). Further, the calculation unit 13 adds, to the DAG, the calculated thread number and memory capacity as necessary resource information, and transmits the DAG to the control unit 14.

When the DAG having necessary resource information added thereto is received, the control unit 14 checks data included in the DAG. In other words, the control unit 14 checks the data management unit 18 as to which piece of data already exists. Alternatively, the control unit 14 checks the data management unit 18 as to which piece of data is cached in the accelerator 3, or swapped in the storage 15. Further, the control unit 14 checks the memory management unit 16 for securable memory capacity. Then, the control unit 14 determines the order of processes to be executed as follows based on the obtained information. Specifically, the control unit 14 facilitates the use of data that is already calculated. Further, the control unit 14 controls to preferentially execute a process of calculating data that is stored in the memory 32 of the accelerator 3. Further, the control unit 14 controls to successively execute a plurality of processes for data (split data). The control unit 14 searches and determines an optimum processing order, taking into consideration the aforementioned matters (Step A8). In other words, the control unit 14 performs optimization of the processing order. Note that executing sequential processes for split data is particularly advantageous when it is not possible to accommodate data to be processed in the memory 32 of the accelerator 3.

Thereafter, the control unit 14 controls the accelerator 3 as follows in such a manner that a process corresponding to each edge of the DAG is executed according to a determined processing order. First of all, the control unit 14 checks whether split data to be processed in a process corresponding to the edge to be executed is already prepared (stored) in the memory 32 of the accelerator 3 (Step A9). Then, when the split data to be processed is not prepared in the accelerator 3 (No in Step A9), the control unit 14 loads the split data on the memory 32 of the accelerator 3 from the storage 15 (Step A10). In this example, as a case in which loading is necessary, it is possible to conceive a case where the split data is erased from the memory 32 of the accelerator 3 by swapping the split data from the memory 32 of the accelerator 3 to the storage 15. Further, as a case in which loading is necessary, it is also possible to conceive a case where the split data is not given to the accelerator 3 because the spilt data is processed in a first DAG process.

Thereafter, the control unit 14 requests the memory management unit 16 for securing the memory capacity necessary for output of a process to be executed (Step A11). In this case, the control unit 14 notifies the memory management unit 16 of information (e.g., the use data number or the split data number), which is necessary for adding information relating to data to be output in the memory management table 17. The memory management unit 16 secures the memory capacity (pages) necessary for the accelerator 3, and registers the notified information in the memory management table 17. Then, the memory management unit 16 notifies the page number of a secured page to the control unit 14. In this example, the lock flag for the secured memory page is asserted.

Thereafter, the control unit 14 notifies the data management unit 18 of information relating to output data to be output from an executed process (in other words, information necessary for adding information relating to output data in the data management table 19). The data management unit 18 registers the notified information in the data management table 19 (Step A12).

Thereafter, the control unit 14 controls the accelerator 3 to execute a process corresponding to the edge of the DAG (Step A13). When the process is completed, the control unit 14 notifies the memory management unit 16 that the process is completed, and releases assertion of the lock flag in the page of the memory 32, which is used for the process. Further, regarding data, which are known to be used in the edge (the process) of any subsequent process in the DAG, the control unit 14 requests the memory management unit 16 to assert the swap request flag of the memory management table 17 in the page in which the data is stored. Further, also regarding data for which a cache request is received from the execution unit 11, the control unit 14 requests the memory management unit 16 to assert the swap request flag.

The control unit 14 continues the processes of Steps A9 to A13 until execution of all the processes designated in the DAG is completed according to an optimum processing order determined in Step A8.

Then, when execution of all the processes of the DAG is finished (Yes in Step A14), the control unit 14 returns to the operation of Step A1.

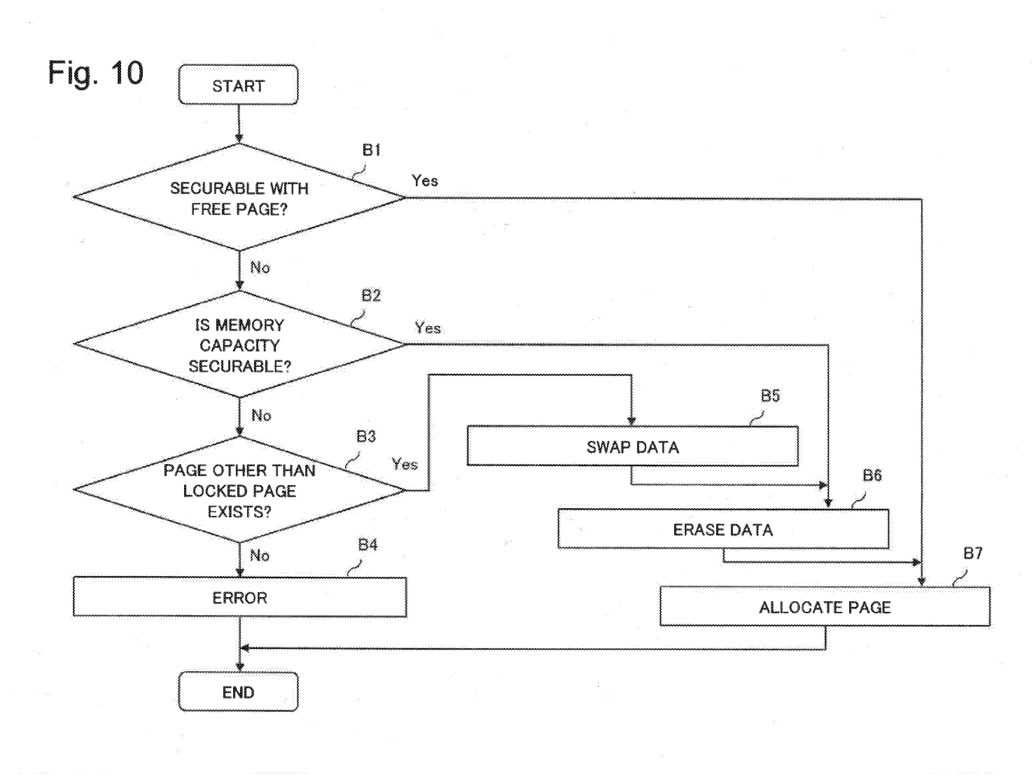

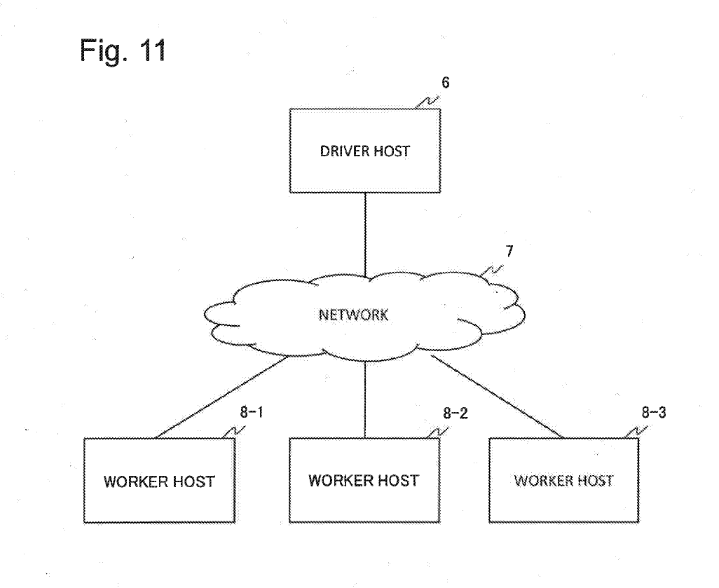

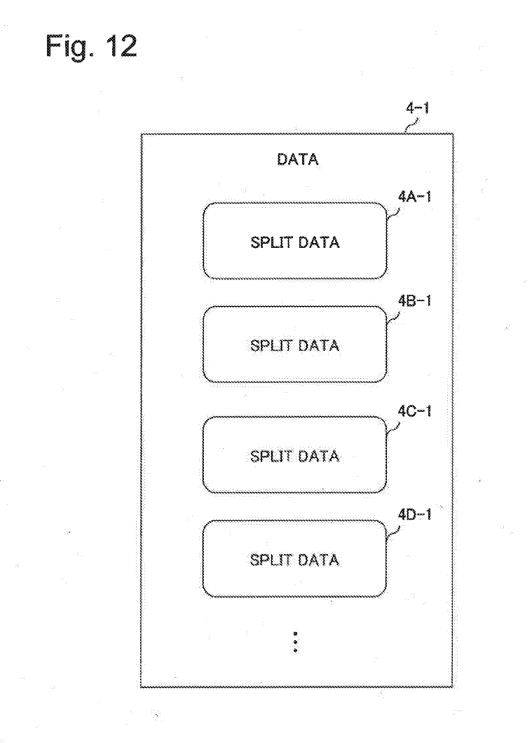

Next, an operation of the memory management unit 16 of allocating pages in order to secure the memory capacity necessary for a process is described using FIG. 10. FIG. 10 is a flowchart illustrating an operation example of the memory management unit 16 regarding a page allocation process.

The memory management unit 16 checks whether there exist free the number of pages corresponding to the requested memory capacity in the memory 32 of the accelerator 3 by referring to the memory management table 17 (Step B1). When it is possible to secure the requested memory capacity only by free pages (Yes in Step B1), the memory management unit 16 allocates the pages as pages for use in a process (Step B7).

On the other hand, when the number of pages is smaller than the number of free pages corresponding to the requested memory capacity (No in Step B1), the memory management unit 16 searches the memory management table 17 for pages in which the lock flag and the swap request flag are not asserted. Then, the memory management unit 16 checks whether it is possible to secure the requested memory capacity by combining searched pages and free pages (Step B2).

In this example, when it is possible to secure the necessary memory capacity (Yes in Step B2), the memory management unit 16 releases whole or part of pages in which neither the lock flag nor the swap request flag is asserted. The memory management unit 16 then erases data stored in the released pages (Step B6). Then, the memory management unit 16 notifies the data management unit 18 that data stored in the released pages is erased.

Further, when it is still not possible to secure the memory capacity in Step B2 (No in Step B2), the memory management unit 16 checks whether it is possible to secure the requested memory capacity by including pages in which the swap request flag is asserted (Step B3).

When it is not possible to secure the requested memory capacity in Step B3 (No in Step B3), the memory management unit 16 responds to the control unit 14 with an error message (Step B4).

Further, when it is possible to secure the requested memory capacity in Step B3 (Yes in Step B3), the memory management unit 16 performs the following operation. Specifically, the memory management unit 16 swaps (transfers), to the storage 15, data stored in whole or part of pages in which the lock flag is not asserted and in which the swap request flag is asserted (Step B5). Then, the memory management unit 16 jointly releases pages in which data is transferred to the storage 15, and pages in which neither the lock flag nor the swap request flag is asserted. The memory management unit 16 then erases data in the released pages (Step B6). Further, the memory management unit 16 notifies the data management unit 18 that data is swapped and pages are released. In this example, the memory management unit 16 executes a process relating to data (Steps B5 and B6) by using split data as a unit.

Thereafter, the data management unit 18 allocates pages depending on the memory capacity requested by the control unit 14, as pages for use in a process (Step B7).

As described above, in the accelerator control device 1 of the first example embodiment, the generation unit 12 generates the DAG (Directed Acyclic Graph) representing a process flow of the user program. The control unit 14 requests the memory management unit 16 for the memory capacity of the accelerator necessary for executing the process indicated in the DAG, and secures the requested memory capacity. The memory management unit 16 preferentially holds, in the memory 32 of the accelerator 3, data for which caching (in other words, storing in the memory 32 of the accelerator 3) is requested, or data to be used in any subsequent process in the DAG. According to the aforementioned configuration, when data already stores in the memory 32 of the accelerator 3 in causing the accelerator 3 to execute the DAG process, the control unit 14 causes the accelerator 3 to use the data as cache data. Further, by causing the accelerator 3 to successively execute a plurality of processes for data in causing the accelerator 3 to execute the DAG process, the control unit 14 is able to cause the accelerator 3 to execute a plurality of processes all at once by loading data to the accelerator 3 by one-time operation.

Specifically, in the accelerator control device 1 of the first example embodiment, the memory management unit 16 secures a minimum memory necessary for the DAG process (calculation) in the memory 32 of the accelerator 3, and holds data which is scheduled to be used in the remaining portion of the memory as much as possible. Therefore, the accelerator 3 is able to execute a process by using, as cache data, data stored in the memory 32. Thus, the accelerator 3 is not required to execute a process of loading data from the storage 15 in the accelerator control device 1, each time the DAG process is executed. Further, the accelerator 3 is able to reduce a process of swapping data from the memory to the storage 15 in the accelerator control device 1. Therefore, the accelerator control device 1 of the first example embodiment is advantageous in executing a high-speed process with use of the accelerator 3.

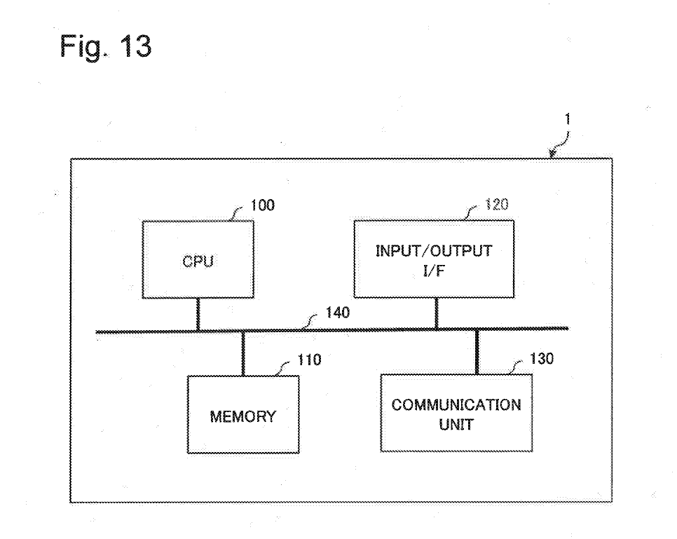

Note that FIG. 13 is a block diagram briefly illustrating an example of hardware components constituting the accelerator control device 1. The accelerator control device 1 includes a CPU (Central Processing Unit) 100, a memory 110, an input-output I/F (Interface) 120, and a communication unit 130. The CPU 100, the memory 110, the input-output I/F 120, and the communication unit 130 are connected to each other via a bus 140. The input-output I/F 120 has a connection configuration that makes it possible to communicate information between a peripheral device such as an input device (a keyboard, a mouse, or the like) or a display device, and the accelerator control device 1. The communication unit 130 has a connection configuration that makes it possible to communicate with another computer via an information communication network. The memory 110 has a configuration for storing data or a computer program. The memory in this example indicates a storage device in a broad meaning, and includes a semiconductor memory, and a hard disk or a flash disk, which is generally called a secondary storage. The CPU 100 is allowed to have various functions by executing a computer program read from the memory. For instance, the execution unit 11, the generation unit 12, the calculation unit 13, the control unit 14, the memory management unit 16, and the data management unit 18 in the accelerator control device 1 of the first example embodiment are implemented by the CPU 100. The memory management table 17 and the data management table 19 are stored in the storage 20 to be implemented by the memory 110.

Whole or part of the aforementioned example embodiment may be described as the following Supplemental Notes, but is not limited to the following.

(Supplemental Note 1)

An accelerator control device includes:

a generation unit that generates a DAG (Directed Acyclic Graph) representing a user program; and

a control unit that, when data corresponding to a node of the DAG are loaded on a memory of an accelerator, controls the accelerator to execute a process corresponding to an edge of the DAG with use of the data loaded on the memory of the accelerator.

(Supplemental Note 2)

When the control unit is operable to successively execute a plurality of processes corresponding to a plurality of edges of the DAG for split data being whole or part of data corresponding to the node of the DAG, the control unit may control the accelerator to successively execute the plurality of processes for the split data loaded on the memory of the accelerator without swapping the split data loaded on the memory of the accelerator.

(Supplemental Note 3)

The accelerator control device may include: a memory management unit that allocates a memory area necessary for calculation of the DAG, while preferentially releasing the memory area storing data that are not used for a process after a process corresponding to the edge of the DAG, out of the memory of the accelerator; a data management unit that manages data on the memory of the accelerator; and a storage that stores data to be loaded on the memory of the accelerator, and data swapped from the memory of the accelerator during the DAG process. The control unit may request the memory management unit for the memory of the accelerator necessary for calculation of the DAG, query the data management unit for data on the memory of the accelerator, and control the accelerator according to a query result.

(Supplemental Note 4)

The accelerator control device may be provided with a table that stores information indicating whether data to be held in each page of the memory of the accelerator are being used for a process corresponding to the edge of the DAG, and information indicating whether swapping of the data is required. The memory management unit may release a page storing data other than data being used for a process corresponding to the edge of the DAG and data for which swapping is not required more preferentially than a page storing data for which swapping is required, by referring to the table in releasing the memory of the accelerator.

(Supplemental Note 5)

The memory management unit may release a plurality of pages storing split data being whole or part of data corresponding to the node of the DAG all at once in releasing the memory of the accelerator.

(Supplemental Note 6)

The user program may use two types of APIs which are a reservation API (Application Programming Interface) and an execution API. The generation unit may continue generation of the DAG in response to calling of the reservation API. The DAG process generated by the generation unit may be triggered in response to calling of the execution API.

(Supplemental Note 7)

The accelerator control device may include an execution unit which requests the generation unit to cache data to be used for calculation over a plurality DAGs in the memory of the accelerator in response to a request by the user program. The generation unit may mark data which receive the cache request. The control unit may request the memory management unit to handle a page to be used by the marked data as a page for which swapping is required, when the page is not locked.

(Supplemental Note 8)

An API to be called by the user program may use, as an argument, a parameter indicating a quantity of data to be generated by a designated process. A DAG to be generated by the generation unit may include a quantity of data to be generated, or a ratio between a quantity of input data and a quantity of output data.

(Supplemental Note 9)

An accelerator control method including:

a step of causing a computer to generate a DAG (Directed Acyclic Graph) representing a user program; and

a step of controlling the accelerator to execute, when data corresponding to a node of the DAG are loaded on a memory of an accelerator, a process corresponding to an edge of the DAG with use of the data loaded on the memory of the accelerator.

(Supplemental Note 10)

The accelerator control method may include a step of causing the computer to control, when it is possible to successively execute a plurality of processes corresponding to a plurality of edges of the DAG for split data being whole or part of data corresponding to a node of the DAG, the accelerator to successively execute the plurality of processes for the split data loaded on the memory of the accelerator without swapping the split data loaded on the memory of the accelerator.

(Supplemental Note 11)

The accelerator control method may include:

a step of causing the computer to allocate a memory area necessary for calculation of the DAG, while preferentially releasing the memory area storing data that are not used for a process after a process corresponding to the edge of the DAG, out of the memory of the accelerator;

a step of managing data on the memory of the accelerator;

a step of storing, in a memory of a computer, data to be loaded on the memory of the accelerator and data swapped from the memory of the accelerator during the DAG process; and

a step of controlling the accelerator according to data on the memory of the accelerator.

(Supplemental Note 12)

The accelerator control method may include:

a step of causing the computer to store, in a table, information indicating whether data to be held in each page of the memory of the accelerator are being used for a process corresponding to the edge of the DAG, and information indicating whether swapping of the data is required; and

a step of releasing a page storing data other than data being used for a process corresponding to the edge of the DAG and data for which swapping is not required, more preferentially than a page storing data for which swapping is required, by referring to the table in releasing the memory of the accelerator.

(Supplemental Note 13)

In the accelerator control method, the computer may release a plurality of pages storing split data being whole or part of data corresponding to the node of the DAG all at once in releasing the memory of the accelerator.

(Supplemental Note 14)

A computer program with a processing procedure represented therein which causes a computer to execute:

a process of generating a DAG (Directed Acyclic Graph) representing a user program; and

a process of controlling the accelerator to execute, when data corresponding to a node of the DAG are loaded on a memory of an accelerator, a process corresponding to an edge of the DAG with use of the data loaded on the memory of the accelerator.

(Supplemental Note 15)

When the computer program is operable to successively execute a plurality of processes corresponding to a plurality of edges of the DAG for split data being whole or part of data corresponding to the node of the DAG, the computer program may cause the computer to execute a process of controlling the accelerator to successively execute the plurality of processes for the split data loaded on the memory of the accelerator without swapping the split data loaded on the memory of the accelerator.

(Supplemental Note 16)

The computer program may cause a computer to execute:

a process of allocating a memory area necessary for calculation of the DAG, while preferentially releasing the memory area storing data that are not used for a process after a process corresponding to the edge of the DAG, out of the memory of the accelerator;

a process of managing data on the memory of the accelerator;

a process of storing, in a memory of the computer, data to be loaded on the memory of the accelerator and data swapped from the memory of the accelerator during the DAG process; and

a process of controlling the accelerator according to data on the memory of the accelerator.

(Supplemental Note 17)

The computer program may cause the computer to execute:

a process of storing, in a table, information indicating whether data to be held in each page of the memory of the accelerator are being used for a process corresponding to the edge of the DAG, and information indicating whether swapping of the data is required; and

a process of releasing a page storing data other than data being used for a process corresponding to the edge of the DAG and data for which swapping is not required, more preferentially than a page storing data for which swapping is required, by referring to the table in releasing the memory of the accelerator.

(Supplemental Note 18)

The computer program may cause the computer to execute a process of releasing a plurality of pages storing split data being whole or part of data corresponding to the node of the DAG all at once in releasing the memory of the accelerator.

In the foregoing, the present invention is described by using the aforementioned example embodiment as an exemplary example. The present invention, however, is not limited to the aforementioned example embodiment. Specifically, the present invention is applicable to various modifications comprehensible to a person skilled in the art within the scope of the present invention.

This application claims the priority based on Japanese Patent Application No. 2014-215968 filed on Oct. 23, 2014, the disclosure of which is hereby incorporated in its entirety.

### REFERENCE SIGNS LIST

1 Accelerator control device
3, 3-1, 3-2 Accelerator
11 Execution unit
12 Generation unit
13 Calculation unit
14 Control unit
15 Storage
16 Memory management unit
18 Data management unit

1. An accelerator control device comprising:
a generation unit that generates a DAG (Directed Acyclic Graph) representing a process flow based on a computer program to be executed; and
a control unit that, when data relating to a node of the DAG is stored in a memory provided in an accelerator to be controlled, controls the accelerator so as to execute a process relating to an edge of the DAG with use of the data stored in the memory of the accelerator.

2. The accelerator control device according to claim 1, wherein,
when a plurality of processes relating to a plurality of edges of the DAG is successively executable for split data, the split data being whole or part of the data relating to a node of the DAG, the control unit controls the accelerator so as to successively execute the plurality of processes for the split data without erasing the split data stored in the memory from the memory of the accelerator each time one of the plurality of processes is finished.

3. The accelerator control device according to claim 1, further comprising:
a memory management unit that allocates a part of the memory of the accelerator as a memory area necessary for a process of the DAG in executing the process relating to an edge of the DAG, and releases a memory area storing data that is not used for any process relating to the edge of subsequent processes in the DAG, out of the memory of the accelerator;
a data management unit that manages data stored in the memory of the accelerator; and
a storage that stores data to be stored in the memory of the accelerator, and data transferred from the memory of the accelerator, wherein
the control unit requests the memory management unit to allocate the memory area of the accelerator necessary for a process of the DAG, queries the data management unit for information on data stored in the memory of the accelerator, and controls transferring and erasing of data stored in the memory of the accelerator depending on a query result.

4. The accelerator control device according to claim 3, further comprising
management information including:
information indicating whether data held in a page is used for a process relating to an edge of the DAG, the page being a split area obtained by splitting the memory of the accelerator into a plurality of area; and
information indicating whether swapping is required, the swapping being transferring data from the memory to the storage, wherein
the memory management unit releases the page storing data that is not used for the process relating to the edge of the DAG and for which swapping is not required, prior to the page storing data for which swapping is required, by referring to the management information, when releasing the memory area of the accelerator.

5. The accelerator control device according to claim 4, wherein
the memory management unit releases a plurality of pages storing split data being whole or part of data relating to the node of the DAG all at once, when releasing the memory area of the accelerator.

6. The accelerator control device according to claim 1, wherein
the process based on the computer program includes a process of calling and executing a reservation API (Application Programming Interface) and an execution API,
the generation unit updates the DAG in response to calling of the reservation API, and
the process of the DAG generated by the generation unit is triggered in response to calling of the execution API.

7. The accelerator control device according to claim 3, further comprising:
an execution unit that requests the generation unit to cache data in the memory of the accelerator based on the computer program, the data being data to be used for the processes relating to the plurality of edges of the DAG, wherein
the generation unit attaches a mark to data to be cached, the mark being information representing that the cache request is received, and
the control unit requests the memory management unit to handle the page to be used by data attached with the mark as a page to be swapped when the page is not locked.

8. The accelerator control device according to claim 6, wherein
the API to be called based on the computer program uses, as an argument, a parameter representing a quantity of data to be generated by a process designated, and
the DAG to be generated by the generation unit further includes a quantity of data to be generated, or a ratio of a quantity of input data for use in a process relating to an edge of the DAG to a quantity of output data calculated by the process.

9. An accelerator control method comprising, by a computer:
generating a DAG (Directed Acyclic Graph) representing a process flow based on a computer program to be executed; and
when data relating to a node of the DAG is stored in a memory provided in an accelerator to be controlled, controlling the accelerator so as to execute a process relating to an edge of the DAG with use of the data stored in the memory of the accelerator.

10. A non-transitory program storage medium storing a processing procedure which causes a computer to execute:
generating a DAG (Directed Acyclic Graph) representing a process flow based on a computer program to be executed; and
when data relating to a node of the DAG is stored in a memory provided in an accelerator to be controlled, controlling the accelerator so as to execute a process relating to an edge of the DAG with use of the data stored in the memory of the accelerator.
